(19) United States
(12) Patent Application Publication
(10) Pub. No.: US 2010/0079877 A1
(43) Pub. Date: Apr. 1, 2010

(54) LENS ASSEMBLY AND IMAGE-TAKING APPARATUS

(76) Inventors: Ikuo TAKI, Odawara (JP); Ryota Sasaki, Saitama (JP); Naoki Sasaki, Saitama (JP)

Correspondence Address: BIRCH STEWART KOLASCH & BIRCH, PO BOX 747, FALLS CHURCH, VA, 22040-0747, US

(21) Appl. No.: 12/559,680

(22) Filed: Sep. 15, 2009

(30) Foreign Application Priority Data
Sep. 30, 2008 (JP) 2008-254772
Sep. 7, 2009 (JP) 2009-206117

(51) Int. Cl. G02B 7/02

(52) U.S. Cl. 359/820; 359/819

(57) ABSTRACT

A lens frame is made of ceramic having a linear expansion coefficient that is about the same as the linear expansion coefficient (5 to 10×10⁻⁶) of glass lenses. Preferably, a pressing ring and spacing rings are also made of ceramic. A lens assembly produced by using the lens frame, the pressing ring and the spacing rings is installed in an automobile or the like.

### BACKGROUND OF THE INVENTION

1. Field of the Invention

The present invention relates to a lens assembly equipped with a lens frame into which lenses are inserted, and to an image-taking apparatus provided with the lens assembly.

2. Description of the Related Art

In recent years, automobiles have been provided with cameras. Meanwhile, nowadays, automobiles are equipped with display screens thanks to the widespread use of car navigation systems. Therefore, many of cameras installed in automobiles can display the state of a blind spot for a driver on a display screen provided in front of the driver's seat.

Incidentally, automobiles may be left outdoors in hot summer and in freezing winter and therefore, a camera installed in an automobile is required to operate properly over an extremely wide range of temperatures. In order to guarantee the proper operation of a vehicle-mounted camera, a lens assembly employed in such a camera needs to be not only lightweight and robust as generally required, but also resistant to stretching and shrinking with temperature for the purpose of preventing the occurrence of a blur due to a change in temperature. To meet these needs, ceramic lens barrels have been devised (see, for example, Japanese Patent Application Publications No. 2006-284991 and No. 2006-292927). Also, the inventors of the present application have proposed to apply ceramic to an optical component (see, for example, Japanese Patent Application Publication No. 2007-238430).

Further, for instance, Japanese Patent Application Publication No. 2007-279557 describes a lens assembly having such a structure that lenses and spacing rings are inserted into a lens barrel through the front opening of the lens barrel, and a pressing ring is screwed on a front part of the lens barrel, thereby fixing the lenses to the lens barrel.

FIG. 1 is a diagram that illustrates the structure of a lens assembly 1.

The lens assembly 1 illustrated in FIG. 1 is provided with a lens barrel 10, and the lens barrel 10 has a hollow part 100 having an object-side opening 101 and an image-forming-side opening 102. Formed on an object-side periphery of the lens barrel 10 is a male thread SR1. From the object-side opening 101, lenses L1 through L4 and spacing rings SP1 through SP3 are inserted while being aligned along the optical axis. In this example, the lenses L1 through L4 and the spacing rings SP1 through SP3, which are provided as optical members, are alternately disposed and sequentially inserted into the hollow part 100 of the lens barrel 10. Incidentally, there is another type of lens barrel that determines the position of each lens by making the edges of the surfaces of the respective lenses touch each other while omitting the spacing rings SP1 through SP3.

Furthermore, the lens assembly 1 illustrated in FIG. 1 is provided with a pressing ring 11 that fixes the lenses L1 through L4 and the spacing rings SP1 through SP3 inserted into the hollow part 100 of the lens barrel 10, by pressing them from the side where the object-side opening 101 is formed. The pressing ring 11 has: a mounting opening 110 into which an object-side part of the lens barrel 10 is inserted; and an optical opening 111 for making a central part of the lens L1 exposed. Among the lenses inserted into the lens barrel, the lens L1 is the one disposed at the position closest to the object. Formed on an inner wall on a mounting opening side of the pressing ring 11 is a female thread SR2 in which the male thread SR1 is engaged. When the male thread SR1 is engaged in the female thread SR2, the edge of an object-side surface of the lens L1 disposed at the position closest to the object on the object side is pressed by the pressing ring 11.

The lens assembly 1 shown in FIG. 1 is assembled by using the pressing ring 11 that presses the lenses L1 through L4 and the spacing rings SP1 through SP3 in the lens barrel 10 toward the image-forming-side opening.

According to Japanese Patent Application Publication No. 2007-279557, the lens barrel 10 is made of a resin material, and glass lenses are used as the lenses L1 through L4. Further, the pressing ring 11 and the spacing rings SP1 through SP3 are made of the same resin material as that of the lens barrel 10.

When the lens assembly 1 illustrated in FIG. 1 is left in an environment with a sever temperature, there is a fear of appearance of a gap or deformation due to a difference in linear expansion coefficient, in a contact portion where there is contact between the lens barrel 10 and each of the lenses L1, L2, L3 and L4; between the lens L1 and the pressing ring 11; between the spacing ring SP1 and the lenses L1, L2; between the spacing ring SP2 and the lenses L2, L3; or between the spacing ring SP3 and the lenses L3, L4. When a gap or deformation appears in the contact portion between the lens barrel 10 and each of the lenses L1, L2, L3 and L4; between the lens L1 and the pressing ring 11; between the spacing ring SP1 and the lenses L1, L2; between the spacing ring SP2 and the lenses L2, L3; or between the spacing ring SP3 and the lenses L3, L4, it is impossible for the lens assembly 1 illustrated in FIG. 1 to deliver predetermined optical performance.

### SUMMARY OF THE INVENTION

In view of the above circumstances, the present invention provides a lens assembly that delivers predetermined optical performance even in an environment where the temperature changes over a wide range, and also provides an image-taking apparatus with the lens assembly.

A lens assembly according to the present invention includes:

a plurality of lenses;

a lens frame having a hollow part into which the lenses are inserted and supporting a peripheral part of the lens disposed at one end; and

a pressing ring fixed to the lens frame and pressing a peripheral part of the lens disposed at the other end among the lenses inserted into the hollow part,

wherein the lenses are either glass lenses or ceramic lenses, and

the lens frame is made of ceramic.

According to the lens assembly of the present invention, considering that all the lenses are glass lenses or ceramic lenses, the lens frame is made of ceramic having a linear expansion coefficient close to the linear expansion coefficient of the glasses lenses or the ceramic lenses. Therefore, even when the lens assembly is left in an environment where the temperature changes over a wide range, no gap or deformation is formed between the lens frame and each of the lenses, so that predetermined optical performance can be maintained. Here, the glass lenses and the ceramic lenses include a compound aspheric lens in which a glass lens or ceramic lens is employed as a base and plastic is formed on a surface of the lens.

In the lens assembly according to the present invention, the pressing ring is preferably made of ceramic.

When the pressing ring also is made of ceramic, no gap or deformation is formed between the lens and the pressing ring or between the lens frame and the pressing ring, which further improves reliability of optical performance.

Here, both the lens frame and the pressing ring are preferably made of ceramic having a linear expansion coefficient in a range between 3×10⁻⁶ and 11×10⁻⁶ inclusive.

More preferably, both the lens frame and the pressing ring are made of ceramic having a linear expansion coefficient in a range between 3×10⁻⁶ and 7×10⁻⁶ inclusive.

Both the lens frame and the pressing ring are preferably made of ceramic having a linear expansion coefficient close to the linear expansion coefficient of the materials forming the glass lenses and the ceramic lenses. For instance, the linear expansion coefficient of the glass lens is about 5×10⁻⁶, and there are other types of lenses that show values close to this linear expansion coefficient. There are various types of ceramic showing values close to this linear expansion coefficient. For example, ceramic derived from zirconia achieves a linear expansion coefficient of about 8 to 11×10⁻⁶, and ceramic derived from silicon carbide achieves a linear expansion coefficient of about 4.0×10⁻⁶. Further, ceramic derived from silicon nitride achieves a linear expansion coefficient of about 3.0×10⁻⁶, and ceramic derived from alumina achieves a linear expansion coefficient of about 7 to 8×10⁻⁶. Furthermore, free-cutting ceramic achieves a linear expansion coefficient of about 3 to 11×10⁻⁶.

Use of any of these types of ceramic achieves a linear expansion coefficient closer to the linear expansion coefficient of the above-described lenses and thus, the lens frame and the pressing ring may be produced by using at least one of these types of ceramic.

The lens assembly according to the present invention may further include a spacing ring made of ceramic and disposed at a position between adjacent two lenses in the hollow part of the lens frame to determine a space between the two lenses.

In this case, the spacing ring is preferably made of ceramic having a linear expansion coefficient in a range between 3×10⁻⁶ and 11×10⁻⁶ inclusive, and more preferably made of ceramic having a linear expansion coefficient in a range between 7×10⁻⁶ and 11×10⁻⁶ inclusive.

The spacing ring is inserted into the lens frame and therefore, the spacing ring is preferably made of ceramic having a linear expansion coefficient somewhat larger than the linear expansion coefficient of the lens barrel and the pressing ring. In this case, a gap is unlikely to be formed between the lens frame and the pressing ring even in a severe environment where the temperature changes over a wide range.

Further, in the lens assembly according to the present invention, preferably, the lens frame is made of ceramic having a linear expansion coefficient smaller than that of the lenses, and

the pressing ring is made of a material having a linear expansion coefficient larger than that of the lenses.

In this case, the lens assembly of the present invention may further include a spacing ring disposed at a position between adjacent two lenses in the hollow part of the lens frame to determine a space between the two lenses.

Even when the lens frame is made of ceramic having a linear expansion coefficient smaller than that of the lenses, if the pressing ring is made of a material with the same linear expansion coefficient as that of the lens frame, there is a fear that the lenses receiving pressure applied by the pressing ring could be deformed due to the difference in linear expansion coefficient between the pressing ring and the lenses.

For this reason, when the lens frame is made of ceramic having a linear expansion coefficient smaller than that of the lenses, the pressing ring is preferably made of a material with a linear expansion coefficient larger than that of the lenses, which reduces the pressure applied to the lenses since the linear expansion of the pressing ring is slightly larger than that of the lenses, thereby preventing the lenses from being deformed.

Furthermore, preferably, the lens assembly according to the present invention further includes a spacing ring disposed at a position between adjacent two lenses in the hollow part of the lens frame to determine a space between the two lenses,

wherein the lens frame and the pressing ring are made of ceramic having a linear expansion coefficient larger than that of the lenses, and

the pressing ring is made of a material having a linear expansion coefficient larger than that of the lens frame and the pressing ring.

When the lens frame and the pressing ring are made of ceramic with a linear expansion coefficient larger than that of the lenses as described above, it is expected that there will be produced looseness between the pressing ring and the lenses.

In order to avoid this situation, it is preferable that the spacing ring, which is disposed between adjacent two lenses among the lenses to determine a space between these two lenses, be made of a material whose linear expansion coefficient is larger than that of the lens frame and the pressing ring. This allows the spacing ring to expand to the extent slightly larger than that of the lenses, thereby preventing the lenses from falling and rattling.

An image-taking apparatus according to the present invention includes:

the lens assembly according to the present invention; and

an imaging device disposed at an image-forming surface of an image-forming optical system that is formed by the lenses inserted into the lens frame.

The image-taking apparatus of the present invention delivers predetermined optical performance even when installed in an automobile and left in a severe environment.

### BRIEF DESCRIPTION OF THE DRAWINGS

FIG. 1 is a diagram that illustrates the structure of a lens assembly 1 to be used in a camera installed in an automobile;

FIG. 2 is a diagram that depicts the structure of a lens assembly 1A according to a first embodiment of the present invention;

FIG. 3 is a diagram that illustrates the structure of a lens assembly 1B according to a second embodiment of the present invention; and

FIG. 4 is a diagram illustrating a camera unit 2 into which the lens assembly 1A illustrated in FIG. 2 is incorporated.

### DETAILED DESCRIPTION OF THE INVENTION

Embodiments of the present invention will be described with reference to the drawings.

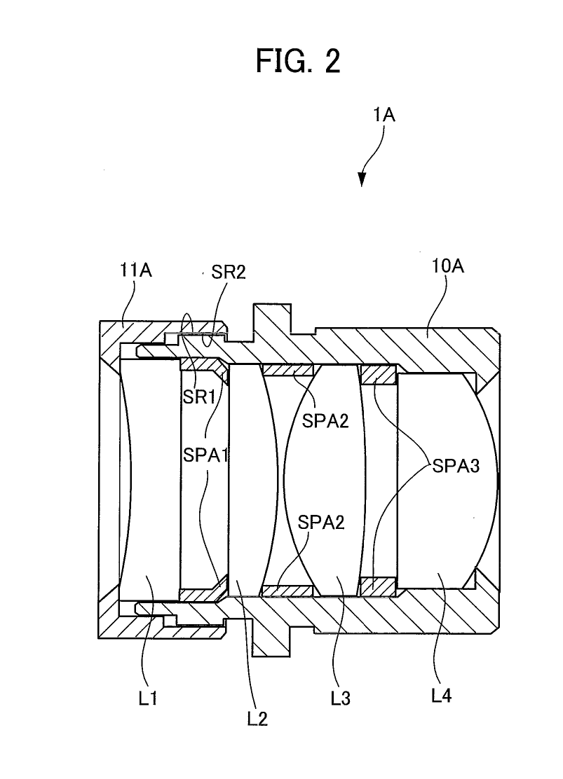

FIG. 2 is a diagram that depicts the structure of a lens assembly 1A according to a first embodiment of the present invention.

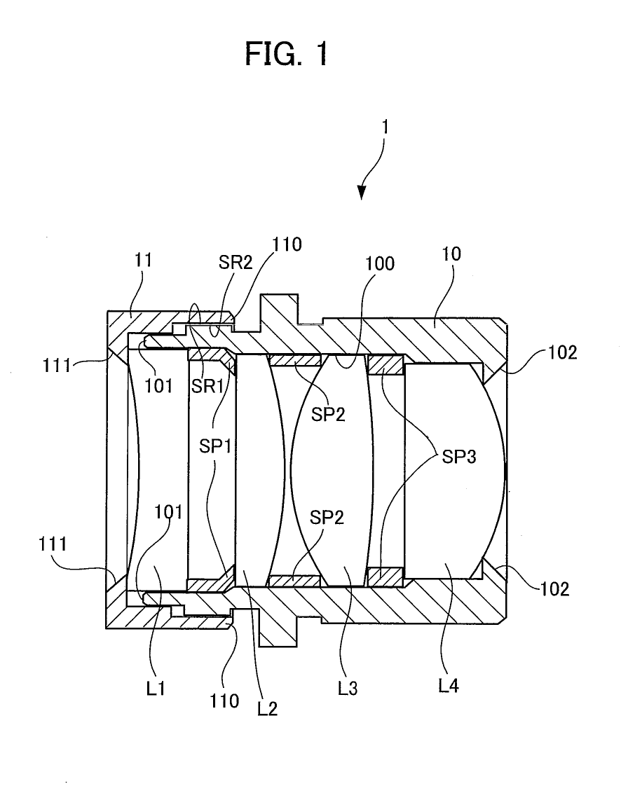

The lens assembly 1A illustrated in FIG. 2 includes a lens frame 10A, a pressing ring 11A and spacing rings SPA1 through SPA3. FIG. 2 is the same as FIG. 1 except that ceramic is used as a material of the lens frame 10A, the pressing ring 11A and the spacing rings SPA1 through SPA3.

In this example, ceramic whose raw material is silicon nitride is used as a material of the lens frame 10A and the pressing ring 11A, and ceramic whose raw material is zirconia is used as a material of the spacing rings SPA1 through SPA3.

The ceramic derived from silicon nitride has a linear expansion coefficient of 3×10⁻⁶, which is about the same as the linear expansion coefficient (5 to 10×10⁻⁶) of glass. The ceramic derived from zirconia has a linear expansion coefficient of 8 to 11×10⁻⁶, which is also about the same as the linear expansion coefficient (5 to 10×10⁻⁶) of glass.

In the example illustrated in FIG. 2, if the ceramic used as the material of the spacing rings SPA1 through SPA3 and the ceramic used as the material of the lens frame 10A and the pressing ring 11A have the same linear expansion coefficients, a gap may be formed between the lens frame 10A as well as the pressing ring 11A and the spacing rings, depending on the temperature. For this reason, the ceramic derived from zirconia is used as the material of the spacing rings SPA1 through SPA3, whose linear expansion coefficient is slightly larger than that of the ceramic used for the lens frame 10A and the pressing ring 11A, so that a gap is prevented from being formed between the lens frame 10A as well as the pressing ring 11A and the spacing rings even in an environment with a severe temperature.

In other words, according to the present invention, both the lens frame and the pressing ring may be made of ceramic having a linear expansion coefficient in a range between 3×10⁻⁶ and 11×10⁻⁶ inclusive, and it is preferable that both the lens frame and the pressing ring be made of ceramic having a linear expansion coefficient in a range between 3×10⁻⁶ and 7×10⁻⁶ inclusive and the spacing ring be made of ceramic having a linear expansion coefficient in a range between 7×10⁻⁶ and 11×10⁻⁶ inclusive.

Accordingly, even when the lens assembly 1A illustrated in FIG. 2 is installed in an automobile or the like and left in a severe environment, a portion where there is contact between the lens frame 10A and each of the lenses L1, L2, L3 and L4; between the lens L1 and the pressing ring 11A; between the spacing ring SPA1 and the lenses L1, L2; between the spacing ring SPA2 and the lenses L2, L3; between the spacing ring SPA3 and the lenses L3, L4; and between the lens frame 10A and the spacing rings SPA1 through SPA3 is made resistant to formation of a gap or occurrence of deformation. This prevents deterioration of optical performance in the lens assembly 1A illustrated in FIG. 2 installed in an automobile or the like.

Incidentally, ceramic such as alumina (7 to 8×10⁻⁶), silicon nitride (3×10⁻⁶), free-cutting ceramic (3 to 11×¹⁰⁻⁶) and the like may be used as a material of the lens frame 10A, the pressing ring 11A and the spacing rings SPA1 through SPA3. The linear expansion coefficients of these types of ceramic are all in the level of 10⁻⁶ and about the same as the linear expansion coefficient of glass lens, ceramic lens and the like. Accordingly, it is possible to produce the same effects as those described above.

Further, in the above example, glass lenses are used as all of the lenses L1 through L4. However, all of the lenses L1 through L4 may be ceramic lenses, lenses employing glass as a base, or lenses employing ceramic as a base.

Here, there will be described a case where a material with a linear expansion coefficient smaller than that of the lenses L1 through L4, such as silicon nitride (3×10⁻⁶) and silicon carbide (4×10⁻⁶), is used as the material of the lens frame 10A in the structure illustrated in FIG. 2.

In this case, if the pressing ring 11A is made of a material having a linear expansion coefficient smaller than that of the lenses L1 through L4 like the lens frame 10A, there is a possibility that expansion of the lenses (5 to 10×10⁻⁶) L1 through L4 may become larger than expansion of the lens frame 10A and the pressing ring 11A, applying pressure from the pressing ring 11A to the lenses L1 through L4, leading to occurrence of distortion of the lenses L1 through L4.

In view of the above possibility, when the lens frame 10A is made of ceramic whose linear expansion coefficient is smaller than that of the lenses L1 through L4, the pressing ring 11A is preferably made of a material (e.g. zirconia (8 to 11×10⁻⁶) and alumina (7 to 8×10⁻⁶)) whose linear expansion coefficient is larger than that of the lenses L1 through L4. In this structure, extension of the lenses L1 through L4 in the direction of an optical axis is absorbed by expansion of the pressing ring 11A whose linear expansion coefficient is larger than that of the lenses L1 through L4. No pressure is applied from the pressing ring 11A to the lenses L1 through L4 and thus, occurrence of distortion or cracking in the lenses is prevented.

As the material with a large linear expansion coefficient used for the pressing ring 11A, besides the above-described ceramic, a metallic material may be used.

However, when a material whose linear expansion coefficient is larger than that of the lenses L1 through L4, such as zirconia (8 to 11×10⁻⁶) and alumina (7 to 8×10⁻⁶), is used as the material of the pressing ring 11A and the lens frame 10A, it is expected that extension of the pressing ring 11A and the lens frame 10A will become slightly larger, producing looseness between the lenses L1 through L4 and the pressing ring 11A, and between the lenses L1 through L4 and the spacing rings. When there is looseness between the lenses or between the lenses and the pressing ring, the lenses may fall or shake in response to vibration caused externally.

Accordingly, when a material whose linear expansion coefficient is larger than that of the lenses L1 through L4, such as zirconia (8 to 11×10⁻⁶) and alumina (7 to 8×10⁻⁶), is used as the material of the pressing ring 11A and the lens frame 10A, it is preferable to form such a structure that a material whose linear expansion coefficient is larger than that of the lenses L1 through L4 is employed as the material of the spacing rings SPA1 through SPA3, thereby absorbing extension of the lens frame 10A and the pressing ring 11A in the direction of the optical axis.

In this structure, even when rattling is very likely to occur between the lenses or between the lenses and the pressing ring, the rattling is prevented by the spacing rings having a linear expansion coefficient larger than that of the lenses.

As the material whose linear expansion coefficient is larger than that of the lenses (5 to 10×10⁻⁶) L1 through L4, it is conceivable to employ a metallic material other than the ceramic materials such as zirconia (8 to 11×10⁻⁶) and alumina (7 to 8×10⁻⁶).

Incidentally, to determine the positions of the lenses within the lens frame, it is conceivable to form such a structure that the edges of the surfaces of the lenses are made to contact each other, while omitting the spacing rings.

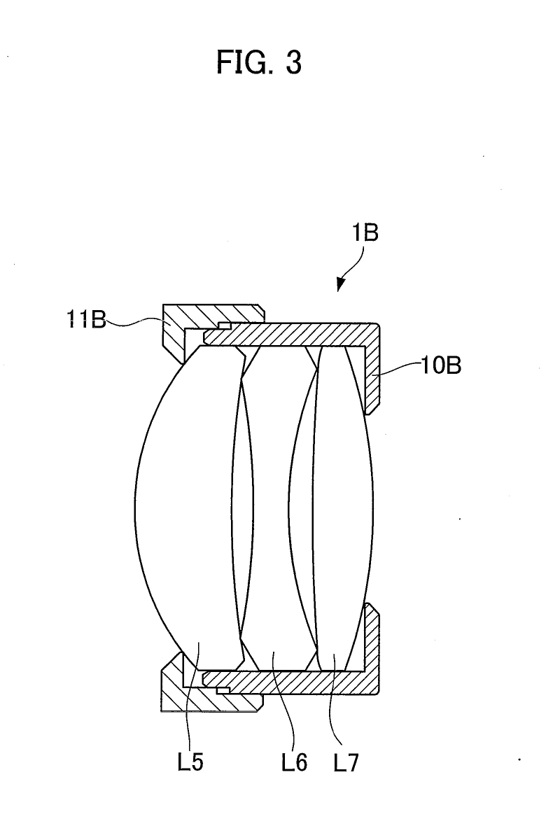

FIG. 3 is a diagram that illustrates the structure of a lens assembly 1B according to a second embodiment of the present invention.

In FIG. 3, when a pressing ring 11B is screwed on a lens frame 10B, the edges of the surfaces of lenses L5, L6 and L7 are made to contact each other, thereby determining the positions of the lenses L5, L6 and L7. The present invention is also applied to this type of structure, and both the lens frame 10B and the pressing ring 11B are made of ceramic having a linear expansion coefficient closer to that of glass lens. In this example, the lens frame 10B and the pressing ring 11B are made of ceramic whose raw material is silicon nitride, and the linear expansion coefficient of this ceramic is 3×10⁻⁶, which is about the same as the linear expansion coefficient (5 to 10×10⁻⁶) of glass.

For this reason, even when the lens assembly 1B illustrated in FIG. 3 is installed in an automobile or the like and left in a severe environment, a portion where there is contact between the lens frame 10B and each of the lenses L5, L6 and L7; between the lens L5 and the pressing ring 11B; or between the pressing ring 11B and the lens frame 10B is made resistant to formation of a gap and occurrence of deformation. As a result, optical performance of the lens assembly 1B illustrated in FIG. 3 installed in an automobile or the like is prevented from deteriorating.

Incidentally, ceramic with a linear expansion coefficient in a range between 3.0×10⁻⁶ and 11.0×10⁻⁶ inclusive, such as alumina (7 to 8×10⁻⁶), silicon nitride (3×10⁻⁶), free-cutting ceramic (3 to 11×10⁻⁶) and the like may be used as a material of the lens frame 10B and the pressing ring 11B. The linear expansion coefficients of these types of ceramic are in the level of 10⁻⁶ and are all about the same as the linear expansion coefficient of glass lens, ceramic lens and the like. Accordingly, in the second embodiment as well, it is possible to obtain the same effects as those described above for the first embodiment.

Lastly, there will be described an example in which the lens assembly 1A illustrated in FIG. 2 is applied to an image-taking apparatus.

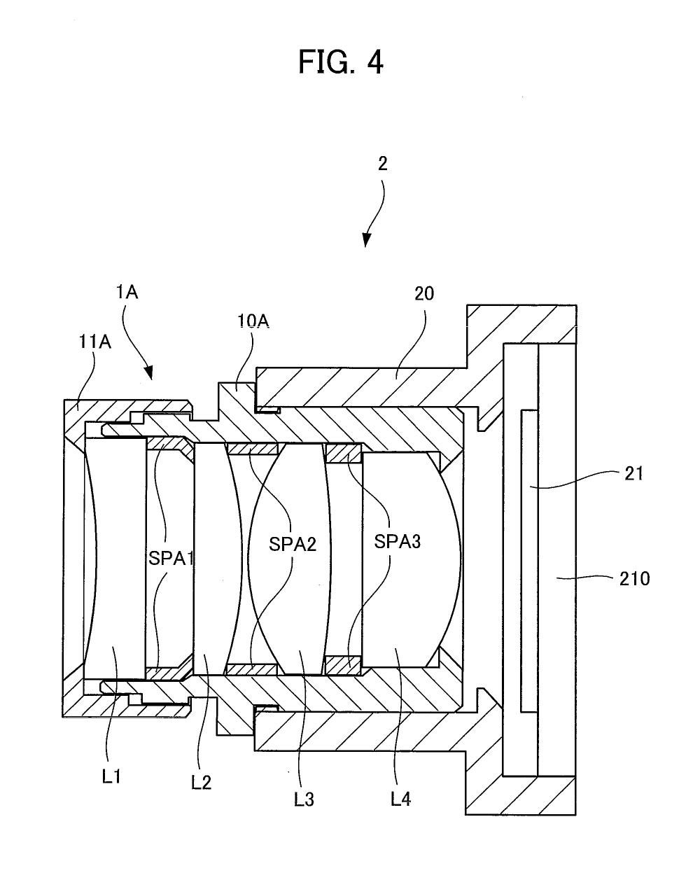

FIG. 4 is a diagram illustrating a camera unit 2 into which the lens assembly 1A illustrated in FIG. 2 is incorporated.

FIG. 4 illustrates a cross section of the camera unit 2, taken along the optical axis.

The camera unit 2 illustrated in FIG. 4 includes: the lens assembly 1A illustrated in FIG. 2, a camera main-unit frame 20 made of ceramic, and an imaging device 21. The imaging device 21 is implemented on an imaging-device board 210 and fixed with adhesion to the camera main-unit frame 20. An outer surface of the lens frame 10A of the lens assembly 1A shown in FIG. 2 and an inner surface of the camera main-unit frame 20 are respectively provided with thread sections.

When the camera unit 2 is assembled, at first, the lens assembly 1A shown in FIG. 2 is screwed into the camera main-unit frame 20 and then, the lens assembly 1A is fixed to the camera main-unit frame 20 with adhesion. Subsequently, the imaging-device board 210 mounted with the imaging device 21 such as a CCD solid-state imaging device is bonded to the camera main-unit frame 20 with adhesion, so that the imaging-device board 210 is positioned at an image-forming surface of an image-forming optical system formed by the lenses L1 through L4 inserted into the lens frame 10A of the lens assembly 1A. By going through this simple procedure, the lens assembly 1A illustrated in FIG. 2 can be incorporated into the camera unit 2.

The camera unit 2 thus assembled delivers predetermined optical performance even when installed in an automobile and left in a severe environment where the temperature changes over a wide range.

As described above, according to the present invention, there is realized: a lens assembly that shows predetermined optical performance even in a severe environment where the temperature changes over a wide range; and an image-taking apparatus provided with such a lens assembly.

What is claimed is:

1. A lens assembly comprising:
a plurality of lenses;
a lens frame having a hollow part into which the lenses are inserted and supporting a peripheral part of the lens disposed at one end; and
a pressing ring fixed to the lens frame and pressing a peripheral part of the lens disposed at the other end among the lenses inserted into the hollow part,
wherein the lenses are either glass lenses or ceramic lenses, and
the lens frame is made of ceramic.

2. The lens assembly according to claim 1, wherein the pressing ring is made of ceramic.

3. The lens assembly according to claim 2, wherein both the lens frame and the pressing ring are made of ceramic having a linear expansion coefficient in a range between 3×10⁻⁶ and 11×10⁻⁶ inclusive.

4. The lens assembly according to claim 2, wherein both the lens frame and the pressing ring are made of ceramic having a linear expansion coefficient in a range between 3×10⁻⁶ and 7×10⁻⁶ inclusive.

5. The lens assembly according to claim 2, further comprising a spacing ring made of ceramic and disposed at a position between adjacent two lenses in the hollow part of the lens frame to determine a space between the two lenses.

6. The lens assembly according to claim 5, wherein the spacing ring is made of ceramic having a linear expansion coefficient in a range between 3×10⁻⁶ and 11×10⁻⁶ inclusive.

7. The lens assembly according to claim 5, wherein the spacing ring is made of ceramic having a linear expansion coefficient in a range between 7×10⁻⁶ and 11×10⁻⁶ inclusive.

8. The lens assembly according to claim 1, wherein the lens frame is made of ceramic having a linear expansion coefficient smaller than that of the lenses, and the pressing ring is made of a material having a linear expansion coefficient larger than that of the lenses.

9. The lens assembly according to claim 8, further comprising a spacing ring disposed at a position between adjacent two lenses in the hollow part of the lens frame to determine a space between the two lenses.

10. The lens assembly according to claim 1, further comprising a spacing ring disposed at a position between adjacent two lenses in the hollow part of the lens frame to determine a space between the two lenses,
wherein the lens frame and the pressing ring are made of ceramic having a linear expansion coefficient larger than that of the lenses, and
the pressing ring is made of a material having a linear expansion coefficient larger than that of the lens frame and the pressing ring.

11. An image-taking apparatus comprising:
the lens assembly according to claim 1; and
an imaging device disposed at an image-forming surface of an image-forming optical system that is formed by the lenses inserted into the lens frame.
